(19) United States
(12) Patent Application Publication
(10) Pub. No.: US 2020/0384685 A1
(43) Pub. Date: Dec. 10, 2020

(54) AXIAL 3D PRINTING

(71) Applicant: Paul. A. Crawford, Seville, OH (US)

(72) Inventor: Paul. A. Crawford, Seville, OH (US)

(21) Appl. No.: 16/880,579

(22) Filed: May 21, 2020

Related U.S. Application Data
(60) Provisional application No. 62/857,446, filed on Jun. 5, 2019.

(51) Int. Cl. B29C 64/141; B33Y 10/00; B33Y 40/20; B33Y 80/00; B29C 64/209; B29C 64/241; B33Y 30/00; B29C 64/245

(52) U.S. Cl. CPC B29C 64/141; B33Y 10/00; B33Y 40/20; B29C 64/245; B29C 64/209; B29C 64/241; B33Y 30/00; B33Y 80/00

(57) ABSTRACT

A method and apparatus of additive manufacturing is provided, along with a 3D printed product, in which 3D printing is implemented axially, according to a cylindrical coordinate system based on the cylindrical axis of shaft. A shaft is provided as a build base. A layer of additive material is deposited onto the surface of the shaft in rows having axial coordinates in an axial direction of the cylindrical axis. Each of the rows are separated from each other by azimuthal coordinates representing angles of rotation around the cylindrical axis. Radial coordinates are displaced from the cylindrical axis such that subsequent layers are similarly deposited atop radially underlying layers, where the layers are separated by layer thicknesses represented by respective radial coordinates. The shaft is supported by a rotating chuck and an extruder is supported by carriages movable in the axial and radial directions.

### CROSS-REFERENCE TO RELATED APPLICATIONS

This application claims the benefit of U.S. Provisional Application No. 62/857,446 entitled AXIAL 3D PRINTING, filed Jun. 5, 2019, which is fully incorporated herein by reference.

### I. BACKGROUND

### A. Technical Field

The present invention relates to the field of additive manufacturing. More particularly, the present invention relates to an apparatus and method for 3D printing, and a 3D printed product formed thereby, in which additive manufacturing is performed with rotation about an axis.

### B. Description of Related Art

The field of additive manufacturing (i.e., 3D printing) provides many benefits over traditional subtractive manufacturing in which material is removed from a workpiece through machining operations. 3D printers are used to form components of a wide range of materials, including plastic and metal. However, conventional 3D printers and methods suffer from certain limitations.

Most common 3D printers operate on a principle of building a workpiece “vertically” by adding material in successive layers to a build base represented by a flat surface. A typical 3D printer deposits material vertically from the plane of the build base according to a cartesian or polar coordinate system.

Due to inherent limitations of the vertical deposition of material, conventional 3D printers are unable to fabricate parts having complex radial features, such as a small jet turbine blade assembly. Such complex radial features would extend horizontally, parallel to the plane of the build base, and would represent void spaces in a vertical column of deposited material that would not support layers above.

Fabricating such complex radial features requires a complicated arrangement of removable supports to accommodate such void spaces. Such supports are removed in order to make a useful part. However, providing such removable supports requires separate fabrication and handling operations which adds significantly to the cost of manufacturing.

In the 3D printing of sinterable materials, a material deposition process is used to fabricate a green part, upon which a sintering operation is performed as a post-processing operation. In conventional 3D printing of sinterable materials, such a green part goes through de-binding from the build base to produce a brown part which requires sintering in a furnace so that the metal particles fuse into a solid object. However, sintering of 3D printed products can result in shrinkage of the part by as much as 20 percent. Also, during sintering the part can also warp or bow, distorting its final shape.

What is needed is an additive manufacturing apparatus and method for forming 3D printed products having complex radial features. What is also needed is a sinterable 3D printing process with reduced shrinkage, warp and bowing.

### II. SUMMARY

In an embodiment of the present invention, an apparatus is disclosed for creating a 3D printed product in which additive manufacturing is performed by rotation about an axis.

The apparatus includes a chuck for supporting a shaft that defines a work surface. The chuck and shaft have a cylindrical axis of rotation. An extruder deposits additive material upon the surface of the shaft at a plurality of selected positions. An axial carriage movably supports the extruder for reciprocal motion in an axial direction of the cylindrical axis. In this manner, the extruder deposits additive material in rows at various positions of the work surface. An azimuthal carriage incrementally rotates the chuck supporting the shaft in an azimuthal direction around the cylindrical axis. In this manner, a series of successive rows of additive material are deposited circumferentially around on the work surface, thereby producing a single layer of additive material. A radial carriage movably supports the extruder for reciprocal motion in a radial direction displaced from the cylindrical axis. Moving the radial carriage enables additive material to be deposited in successive layers circumferentially centered on the cylindrical axis.

In the aforementioned manner, 3D printing is implemented axially, according to a cylindrical coordinate system based on the cylindrical axis of shaft, instead of the typical cartesian or polar coordinates of common 3D printers, referenced to the plane of the build base.

According to other aspects of the present disclosure, a method is disclosed for creating a 3D printed product in which additive manufacturing is performed by rotation about an axis.

In a method embodiment, a shaft is provided having a surface and a cylindrical axis. The surface includes positions referenced to a coordinate system of the cylindrical axis, comprising azimuthal coordinates defined by angles around the cylindrical axis, axial coordinates in an axial direction of points along the cylindrical axis, and radial coordinates of points displaced from the cylindrical axis. A first layer is formed by depositing an additive material at a plurality of positions upon the surface of the shaft. These positions have a respective plurality of azimuthal and axial coordinates, along with a common radial coordinate corresponding to the distance of the surface of the shaft. A subsequent plurality of layers are formed by depositing the additive material at a plurality of respective positions upon a surface of a respective underlying layer. That is, a second layer is formed atop the first layer, and a subsequent third layer is formed atop the second layer, etc. The respective plurality of positions of each of the subsequent plurality of layers each have a respective plurality of azimuthal and axial coordinates and radial coordinates corresponding to a distance from the cylindrical axis of the surface of the underlying layer. In this manner, the layers are separated by layer thicknesses represented by respective radial coordinates.

By forming the first and subsequent plurality of layers, the method produces a 3D printed product having one or more predetermined cross-sectional profiles. In additional embodiments, the cross-sectional profiles can be an axial cross-sectional profile or a radial cross-sectional profile. An axial cross-sectional profile can be a profile represented by a plane bisecting the product along some portion of the cylindrical axis of the shaft. Conversely, a radial cross-sectional profile can be a profile represented by a plane intersecting the product at an angle to the cylindrical axis of the shaft, where the angle can be perpendicular to the axis. For example, the radial cross-sectional profile can include forming uniform radial features such as a gear or non-uniform features such as a cam that extend from the cylindrical axis in a radial direction.

According to further aspects of the present disclosure, a 3D printed product is formed according to the apparatus and method of the present invention in which additive manufacturing is performed by rotation about an axis.

In a 3D printed product embodiment, a first layer is formed by depositing an additive material at a plurality of positions upon the surface of the shaft. These positions each have a respective plurality of azimuthal and axial coordinates and radial coordinates corresponding to points on the surface of the shaft. A subsequent plurality of layers are formed by depositing the additive material at a plurality of respective positions upon a surface of an underlying layer. The positions of each of the subsequent plurality of layers have a respective plurality of azimuthal and axial coordinates and radial coordinates corresponding to a distance from the cylindrical axis of points on the surface of the underlying layer. One or more predetermined cross-sectional profiles are formed by the first and subsequent plurality of layers, in the manner briefly indicated hereinabove.

Other benefits and advantages of this invention will become apparent to those skilled in the art to which it pertains upon reading and understanding of the following detailed specification.

### III. BRIEF DESCRIPTION OF THE DRAWINGS

The disclosed 3D printed product and corresponding methods and systems may take physical form in certain parts and arrangement of parts, embodiments of which will be described in detail in this specification and illustrated in the accompanying drawings which form a part hereof and wherein:

FIG. 1 is a front perspective view of a 3D printing apparatus in accordance with an embodiment of the present invention;

FIG. 2 is a front perspective view of a shaft for supporting a workpiece in accordance with the 3D printing apparatus of FIG. 1 for implementing a method embodiment of the present invention;

FIG. 3 is a side-sectional view of the shaft with an exemplary workpiece having an axial cross-sectional profile in accordance with the 3D printing apparatus of FIGS. 1 and 2;

FIGS. 4A and 4B are cross-sectional views of the shaft with respective exemplary workpieces having a radial cross-sectional profile in accordance with the 3D printing apparatus of FIGS. 1 and 2;

FIGS. 5A and 5B are cross-sectional views respectively showing an exemplary workpiece before and after removal from the shaft in accordance with the 3D printing apparatus of FIGS. 1 and 2; and

FIG. 6 is a side view of the shaft with an exemplary workpiece formed together as an integral assembly in accordance with the 3D printing apparatus of FIGS. 1 and 2.

FIG. 7 is a side-sectional view depicting a structure for supporting parts to be sintered in a furnace during a sintering operation.

### IV. DETAILED DESCRIPTION

Referring now to the drawings wherein the showings are for purposes of illustrating embodiments of the method and apparatus for 3D printing, and the resulting 3D printed product, only and not for purposes of limiting the same, and wherein like reference numerals are understood to refer to like components.

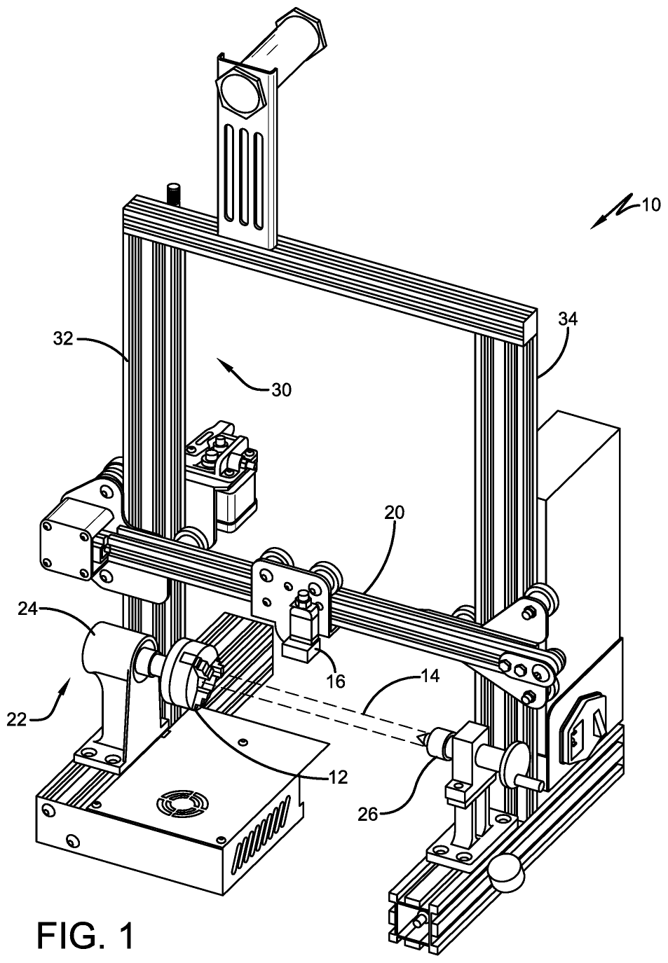

FIG. 1 shows an embodiment of an apparatus 10 for creating a 3D printed product in accordance with the present invention. A chuck 12 supports a shaft 14 (shown in phantom) that defines a work surface upon which the 3D printed product is formed. The chuck 12 and the shaft 14 have a cylindrical axis of rotation, as will be explained in greater detail hereinbelow.

An extruder 16 deposits additive material upon the surface of the shaft 14 at a plurality of selected positions. The extruder 16 deposits additive material at these positions on the surface of the shaft 14 in order to build up the 3D printed product in a layer-by-layer fashion. The extruder 16 can be a typical 3D printer head for dispensing a suitable additive material such as plastic to produce a finished product or a sinterable metal material that is sintered in a subsequent heating operation. A second, third, or subsequent number extruder 16 can also be implemented so that each extruder 16 could dispense a respective different material.

An axial carriage 20 movably supports the extruder 16 for reciprocal motion in an axial direction of the cylindrical axis. In this manner, the extruder 16 is configured to deposit additive material in a row on selected positions of the work surface of the shaft 14. As shown, the axial carriage 20 can be a horizontal bar upon which the extruder 16 can slide back and forth in a reciprocating manner in an axial direction parallel to the cylindrical axis using a motor, rollers, a pully system, or the like. However, the extruder 16 could alternatively be supported by a freestanding movable arm or any other suitable device, without departing from the invention.

An azimuthal carriage 22 incrementally rotates the chuck 12 supporting the shaft 14 in an azimuthal direction around the cylindrical axis. The azimuthal carriage 22 can include a motor 24 that can enable small, incremental movements in a direction of rotation around the cylindrical axis. The azimuthal carriage 22 can also include a spindle 26 for supporting an opposite end of the shaft 14, in order to provide secure, stable support for the work surface. Thus, the azimuthal carriage 22 operates in a manner similar to a lathe, supporting a rotatable workpiece. By rotating the shaft 14 by a small, incremental amount with the azimuthal carriage 22, a series of successive rows of additive material are deposited circumferentially around on the work surface, in such a way that each row adjoins the next immediately adjacent row. By depositing rows around the entire circumference of the shaft 14, a single layer of additive material is produced.

A radial carriage 30 movably supports the extruder 16 for reciprocal motion in a radial direction displaced from the cylindrical axis. As shown, the radial carriage 30 can include a pair of support arms 32, 34 that support the axial carriage 20 at either end. The axial carriage 20 can then be movably displaced in the radial direction using a motor, rollers, a pully system, or the like. Upon completion of a layer, the axial carriage 20 is displaced in the radial direction by an amount corresponding to the thickness of a single layer, in order to begin deposition of the next successive layer. In this manner, additive material is deposited in successive layers circumferentially centered on the cylindrical axis.

In the aforementioned manner, 3D printing is implemented axially, according to a cylindrical coordinate system based on the cylindrical axis of shaft, instead of the typical cartesian or polar coordinates of common 3D printers, referenced to the plane of the build base. It is to be understood and appreciated that the positions of deposited additive material in each layer are controlled by a control system of the type commonly used in additive manufacturing systems in which the coordinates of each application of the deposited material is saved in a suitable data file, in order to fabricate the desired 3D printed product in accordance with the necessary specifications.

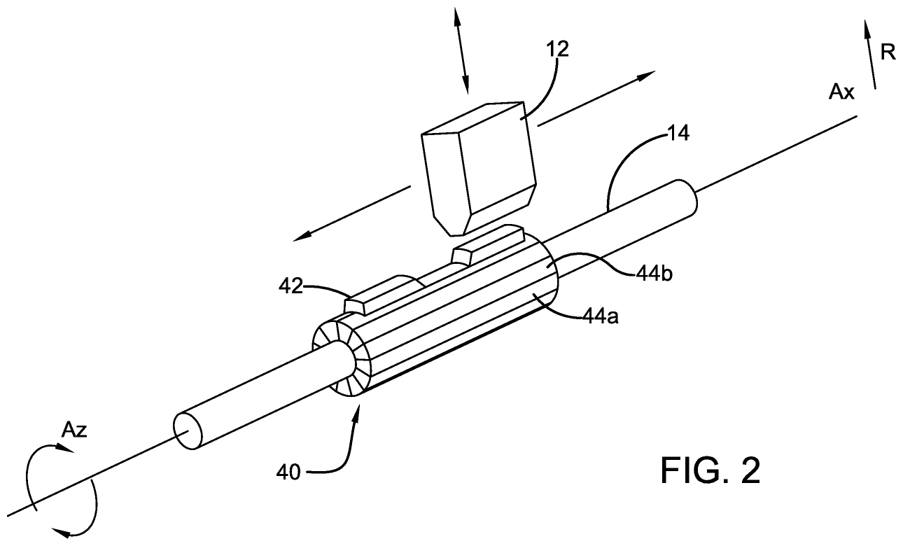

FIG. 2 will now be referenced in order to disclose other aspects of the present disclosure pertaining to a method for creating 3D printed product in which additive manufacturing is performed with rotation about an axis.

In the method of the present invention, according to FIG. 2, the shaft 14 includes the cylindrical axis Ax and a surface defined according to positions referenced to a coordinate system of the cylindrical axis, referenced by the extruder 16 in depositing the additive material. In this cylindrical coordinate system, azimuthal coordinates are defined at angles Az around the cylindrical axis. Axial coordinates are defined in an axial direction along the cylindrical axis Ax, and radial coordinates are defined at positions R displaced in any direction away from the cylindrical axis.

In forming the 3D printed product, a first layer 40 is formed by depositing an additive material at a plurality of positions upon the surface of the shaft. These positions at which additive material are deposited have a respective plurality of azimuthal and axial coordinates and radial coordinates corresponding to points on the surface of the shaft 14. A subsequent plurality of layers are formed by depositing the additive material at a plurality of respective positions upon a surface of a respective underlying layer. That is, a second layer 42 is formed atop the first layer, and a subsequent third layer is formed atop the second layer, etc.

Each of the respective layers 40, 42, etc. are formed by depositing the additive material at positions in rows 44a, 44b, etc. each having the same azimuthal coordinate. Each row should be understood as being formed of a plurality of deposits of additive material along with void spaces, in accordance with the desired radial pattern of the finished 3D printed product. For example, as shown in FIG. 2, the first layer 40 may include rows of continuous additive material while the second layer 42 can include void spaces representing discontinuities between sections of additive material, in order to produce a suitable resulting radial pattern. This is accomplished by displacing the extruder 12 to a selected position using the axial carriage 20.

While the deposits and void spaces are deposited to form a single row of points having the same azimuthal coordinate, each successive row 44a, 44b, etc. is formed to have a different azimuthal coordinate from each other row. This is accomplished by rotating the shaft 14 either clockwise or counterclockwise by a suitable incremental amount corresponding to the different azimuthal coordinate of a respective row. In other words, the first indicated row 44a has an azimuthal coordinate representing a suitable angle of rotation from the second indicated row 44b which is accomplished by incrementally rotating the shaft 14 using the azimuthal carriage 22. However, it is to be appreciated that successive rows 44a, 44b could similarly be deposited by displacing a movable extruder 12 around a stationary shaft 14 by an amount corresponding to the different azimuthal coordinate of a respective row, using a movable arm or the like.

Subsequent layers 40, 42, etc. are formed by displacing the extruder 12 by an amount of a radial coordinate corresponding to a distance from the cylindrical axis of points on the surface of the underlying layer. That is, the second layer 42 has a radial coordinate corresponding to that of the first layer plus the thickness of the first layer. In this manner, the layers are separated by layer thicknesses represented by respective radial coordinates.

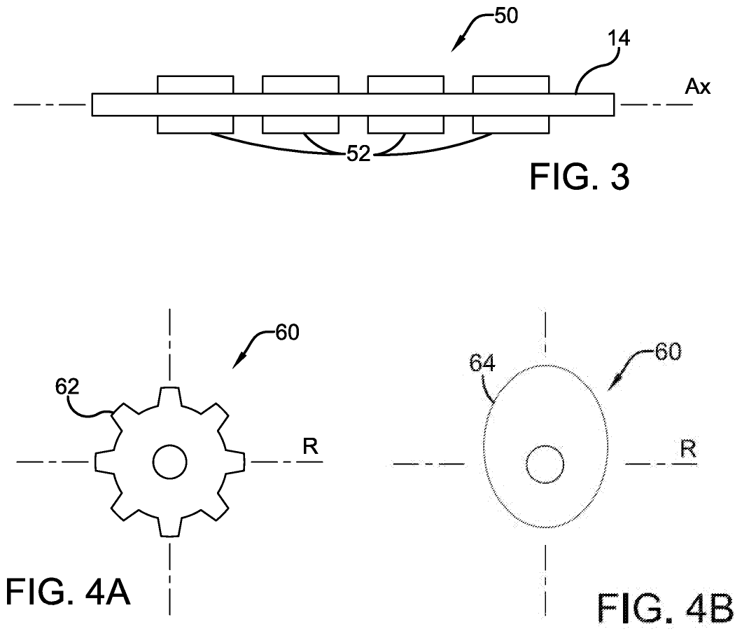

By forming a plurality of layers, the method of the present invention produces a 3D printed product having one or more predetermined cross-sectional profiles. The cross-sectional profiles can be an axial cross-sectional profile, as shown in FIG. 3, or a radial cross-sectional profile, as shown in FIGS. 4A and 4B.

The axial cross-sectional profile 50 of FIG. 3 can be a profile represented by a plane bisecting the product along some portion of the cylindrical axis Ax of the shaft 14. As shown, the axial profile 50 indicates a side-section of 3D printed product features 52 formed on the shaft 14. These features 52 can represent any respective number of layers shown along that profile 50. Different profiles 50 can represent different sections taken along different bisecting planes.

The radial cross-sectional profile 60 of FIGS. 4A and 4B can be a profile represented by a plane intersecting the 3D printed product at an angle to the cylindrical axis Ax of the shaft 14, where the profile as shown is centered on the cylindrical axis Ax. As shown in FIG. 4A, the radial cross-sectional profile 60 can indicate the formation of radial features such as a gear 62. Such an embodiment shows a uniform layer structure in which teeth of the gear 62 include more layers and thus a greater radial coordinate distance than the mating spaces in between. Alternatively, as shown in FIG. 4B, the radial features can be eccentric, such as a cam 64, having a non-uniform radial coordinate distance at various points along its perimeter, that is, having certain features that extend away from the cylindrical axis at a greater distance in the radial direction than certain other features.

As depicted in FIGS. 4A and 4B, the radial cross-sectional profile of the 3D printed product can be taken at an angle perpendicular to the cylindrical axis Ax. However, a cross-section of the 3D printed product can alternately be formed at any non-perpendicular angle for any suitably shaped product, corresponding to shapes such as a worm gear or the like.

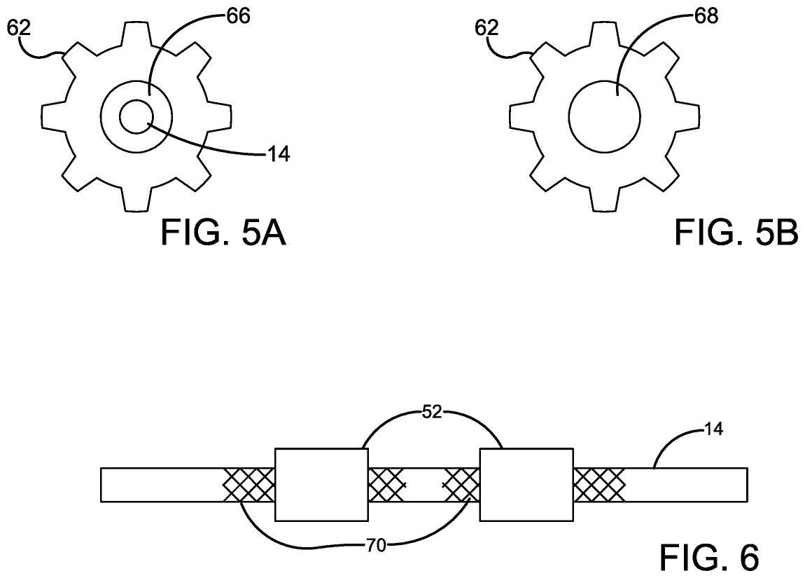

FIGS. 5A and 5B illustrate further innovative embodiments in which the method of the present invention can include steps of a post-processing operation performed on the 3D printed product. In one embodiment, the post-processing operation includes removing the 3D printed product from the shaft 14. As shown in FIGS. 5A and 5B, a 3D printed product such as the gear 62 can have a central void 68 with a cylindrical shape corresponding to the shape and diameter of the shaft 14.

This embodiment can be implemented by forming the shaft 14 and/or the first layer 40 along with a selected number of subsequent layers of a meltable or dissolvable material 66 to facilitate removal of the 3D printed product from the shaft 14, By forming a meltable layer of, for example, plastic having a low melting point, heat can be applied to melt away the meltable material 66 and thereby separate the 3D printed product. A dissolvable material 66 can dissolve in water, solvent or other liquid, and can enable separation of the 3D printed product from the shaft 14. Such meltable or dissolvable material 66 could be deposited using a second extruder 16 as explained hereinabove.

In the example of FIGS. 5A and 5B, the shaft 14 can be a cylindrical shaft that leaves behind a cylindrical void 68 having a uniform diameter around the cylindrical axis in the 3D printed product. In such an embodiment, the respective radial coordinates of each layer represent respective uniform radial distances from the cylindrical axis.

However, it is contemplated that the shaft 14 need not be cylindrical but could also include any non-cylindrical shaft shapes. Such a shaft 14 could be conical, spherical, or having a square, rectangular, or other polygonal-shaped cross-sectional profiles. Such a shaft 14 could have a continuous cross-sectional area across its length or could be tapered or include any sort of non-radially symmetrical profiles (such as the cam 64), or any other possible shaft shapes having any sort of cross-sectional or radial profiles, all without departing from the present invention. In such embodiments, the radial distances from the cylindrical axis would be non-uniform over the extent of the axial distance of the 3D printed product.

In the method of the present invention as described hereinabove, the fabrication of a 3D printed product using plastic as the additive material would result in the production of a finished part. However, an embodiment is contemplated in which the method of the present invention is used with a sinterable material as the additive material. In such an instance, a green part is 3D printed onto the shaft 14, and after which a sintering operation is performed as post-processing operation. This results in an equalization of the shrinking and warping commonly encountered with prior art methods, and also reduces bowing of the part due to its own weight.

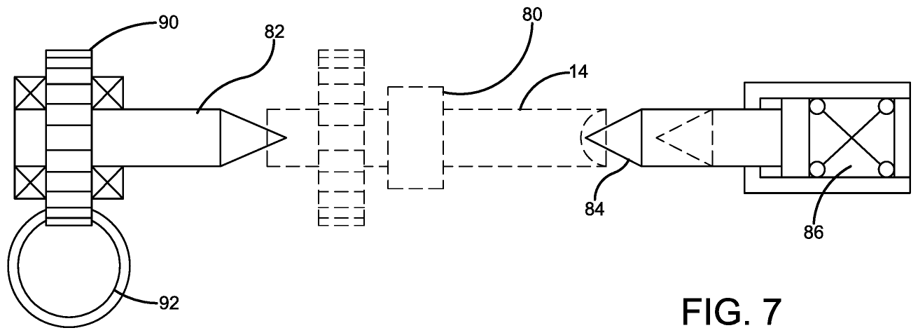

FIG. 7 depicts a structure for supporting parts to be sintered in a furnace during a sintering operation. The shaft 14 with a 3D printed part 80 to be sintered formed thereon is loaded and supported between two centers 82, 84. A driven center 82 slowly rotates the shaft 14 together with the part 80 while the following center 84 maintains compression on the shaft 14 and part 80. A high temperature spring (or alternatively a gas spring) 86 loads the shaft 14 and part 80 toward the driven center 82 to allow for part shrink. The shaft 14 and part 80 are rotated together in the furnace and thereby reduced warp and bowing. The shaft 14 is rotated by a worm gear 90 which itself is driven by a worm shaft 92. Multiple assemblies could be driven by the same worm shaft 92.

In the aforementioned method, such a part can be de-binded after sintering by including a layered central portion around the shaft 14 made of a dissolvable material 66, as explained hereinabove. Upon dissolving the material 66, a finished sintered 3D printed product results in a “hollow” product having a central void 68 of a required diameter, free of shrinking, warping, and bowing.

An alternative embodiment is shown in FIG. 6 in which a sintered 3D printed product can be formed in which the shaft 14 and the additive material are of the same material. Upon sintering, the shaft 14 becomes fused with the 3D printed product features 52. Thus, the shaft 14 is integrally formed with the 3D printed product features 52 to become part of the finished 3D printed product. Adhesion between the shaft 14 and the 3D printed product features 52 can be enhanced by performing a preliminarily operation on the shaft 14 of forming a functional grip surface such as a knurled surface 70. Promotion of adhesion between the shaft and the additive material would improve the performance of components that transmit torque, for example, a printer feeder shaft that have gears and sprockets assembled directly thereon.

The present invention also includes a 3D printed product formed according to the apparatus and method in which additive manufacturing is performed by rotation about a cylindrical axis Ax. In a 3D printed product embodiment, a first layer 40 is formed by depositing an additive material at a plurality of positions upon the surface of the shaft 14. These positions each have a respective plurality of azimuthal and axial coordinates, along with radial coordinates corresponding to points on the surface of the shaft 14. A subsequent plurality of layers are formed by depositing the additive material at a plurality of respective positions upon a surface of an underlying layer. The respective plurality of positions of each of the subsequent plurality of layers have a respective plurality of azimuthal and axial coordinates and radial coordinates corresponding to a distance from the cylindrical axis Ax of points on the surface of the underlying layer. One or more predetermined cross-sectional profiles are formed by the first subsequent plurality of layers, in the manner indicated hereinabove.

Numerous embodiments have been described herein. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A method of creating a 3D printed product comprising:
providing a shaft having a surface and a cylindrical axis, wherein the surface includes positions referenced to a coordinate system comprising azimuthal coordinates at angles around the cylindrical axis, axial coordinates in an axial direction of the cylindrical axis, and radial coordinates displaced from the cylindrical axis;
forming a first layer by depositing an additive material at a plurality of positions upon the surface of the shaft, the plurality of positions having a respective plurality of azimuthal and axial coordinates and radial coordinates corresponding to points on the surface of the shaft;
forming a subsequent plurality of layers by depositing the additive material at a plurality of respective positions upon a surface of an underlying layer, the respective plurality of positions of each of the subsequent plurality of layers having a respective plurality of azimuthal and axial coordinates and radial coordinates corresponding to a distance from the cylindrical axis of points on the surface of the underlying layer; and
producing a 3D printed product having at least one predetermined cross-sectional profile by the forming of the first and subsequent plurality of layers.

2. The method of claim 1, further comprising performing a post-processing operation on the 3D printed product.

3. The method of claim 2, wherein the post-processing operation comprises removing the 3D printed product from the shaft such that the 3D printed product has a central void having a shape corresponding to the shaft.

4. The method of claim 3, further comprising forming the shaft or at least the first layer of a meltable or dissolvable material to facilitate removal of the 3D printed product from the shaft.

5. The method of claim 2, further comprising using a sinterable material as the additive material such that the 3D printed product is a green part, and wherein the post-processing operation comprises a sintering operation.

6. The method of claim 1, further comprising forming the shaft and the additive material are of the same material so that the shaft is integrally formed as part of the 3D printed product.

7. The method of claim 6, further comprising preliminarily forming the shaft to have a functional grip surface to promote adhesion between the shaft and the additive material.

8. The method of claim 1, wherein the providing the shaft comprises providing a cylindrical shaft with a uniform diameter around the cylindrical axis, and wherein the respective radial coordinates of each layer are respective uniform radial distances from the cylindrical axis.

9. The method of claim 1, wherein forming each of the respective layers comprises depositing the additive material at positions in rows having the same azimuthal coordinate and depositing each successive row at a different azimuthal coordinate from each other row.

10. The method of claim 9, wherein depositing each successive row comprises rotating the shaft an amount corresponding to the different azimuthal coordinate of a respective row.

11. The method of claim 9, wherein depositing each successive row comprises displacing an extruder of the additive material around the shaft by an amount corresponding to the different azimuthal coordinate of a respective row.

12. The method of claim 1, wherein the forming at least one predetermined cross-sectional profile comprises forming an axial cross-sectional profile or a radial cross-sectional profile.

13. The method of claim 12, wherein forming the radial cross-sectional profile comprises a forming gear or a cam.

14. A 3D printed product comprising:
a first layer formed by depositing an additive material at a plurality of positions upon the surface of the shaft, the plurality of positions having a respective plurality of azimuthal and axial coordinates and radial coordinates corresponding to points on the surface of the shaft;
a subsequent plurality of layers formed by depositing the additive material at a plurality of respective positions upon a surface of an underlying layer, the respective plurality of positions of each of the subsequent plurality of layers having a respective plurality of azimuthal and axial coordinates and radial coordinates corresponding to a distance from the cylindrical axis of points on the surface of the underlying layer; and
at least one predetermined cross-sectional profile formed by the first and subsequent plurality of layers.

15. The 3D printed product of claim 14, wherein the additive material comprises a sinterable material such that the 3D printed product is a green part upon which a post-processing sintering operation is performed to form a sintered product.

16. The 3D printed product of claim 15, wherein sinterable material is the same material as the shaft so that, upon sintering, the shaft is integrally formed as part of the 3D printed product.

17. The 3D printed product of claim 15, wherein the at least one predetermined cross-sectional profile comprises an axial cross-sectional profile or a radial cross-sectional profile.

18. The 3D printed product of claim 17, wherein the axial cross-sectional profile comprises a gear or a cam.

19. An apparatus for creating a 3D printed product comprising:
a chuck for supporting a shaft defining a work surface and having a cylindrical axis of rotation;
an extruder for depositing additive material at a plurality of positions upon the surface of the shaft;
an axial carriage for movably supporting the extruder for reciprocal motion in an axial direction of the cylindrical axis, to deposit additive material at positions in rows;
an azimuthal carriage for incrementally rotating the chuck supporting the shaft in an azimuthal direction around the cylindrical axis, to deposit additive material in successive rows; and
a radial carriage for movably supporting the extruder for reciprocal motion in a radial direction displaced from the cylindrical axis, to deposit additive material in successive layers centered on the cylindrical axis.

20. The apparatus of claim 19, wherein the extruder is adapted to deposit a sinterable material as the additive material.
